(19) United States
(12) Patent Application Publication
(10) Pub. No.: US 2003/0116685 A1
(43) Pub. Date: Jun. 26, 2003

(54) Folding leg system

(76) Inventor: Jonathan K. Jensen, Medford, OR (US)

Correspondence Address: Charles A. Mirho, 112 W. 37th St., Vencouver, WA, 98660, US

(21) Appl. No.: 10/035,892

(22) Filed: Dec. 24, 2001

(51) Int. Cl. F16M 11/00

(52) U.S. Cl. 248/200; 248/300

(57) ABSTRACT

A folding leg system includes a first leg adapted to receive a first pivot bolt. A first bracket is mounted on a surface and coupled to the first leg by way of the first pivot bolt, such that the first leg can rotate in the first bracket between an up and a down positions. A second leg adapted to receive a second pivot bolt. A second bracket is mounted on the surface and coupled to the second leg by way of the second pivot bolt. The second bracket includes a first section in which the second leg may rotate to a down position from an up position and a second section in which the leg is prevented from rotating into the down position from the up position. The second bracket is adapted so that the second leg may slide along the pivot bolt from the first to the second sections. The first bracket is mounted on the surface across from the second bracket, such that the first leg does not contact the second leg when the first and second legs are in the up position and the second leg is in the second section of the second bracket.

### TECHNICAL FIELD

This invention relates to folding leg systems. More specifically, the invention relates to brackets for folding legs.

### BACKGROUND

Many types of surfaces, such as tables, counter-tops, work benches, and grills, may be supported by legs which fold between various positions. During storage and transportation, the legs of such surfaces may be folded in an “up” position, substantially parallel with the surface to which the are coupled. When the surface is in use, the legs may be folded “down” in order to support the surface.

Many conventional folding leg systems involve complex arrangements of springs, actuators, and sliders, which decreases the robustness and reliability of such systems. Such systems also tend to be more expensive to manufacture and more difficult to assemble.

### SUMMARY

A folding leg system includes a first leg adapted to receive a first pivot bolt. A first bracket is mounted on a surface and coupled to the first leg by way of the first pivot bolt, such that the first leg can rotate in the first bracket between an up and a down positions. A second leg adapted to receive a second pivot bolt. A second bracket is mounted on the surface and coupled to the second leg by way of the second pivot bolt. The second bracket includes a first section in which the second leg may rotate to a down position from an up position and a second section in which the leg is prevented from rotating into the down position from the up position. The second bracket is adapted so that the second leg may slide along the pivot bolt from the first to the second sections. The first bracket is mounted on the surface across from the second bracket, such that the first leg does not contact the second leg when the first and second legs are in the up position and the second leg is in the second section of the second bracket.

### DRAWINGS

FIG. 1 is an illustration of an embodiment of a bracket.

FIG. 2 is an illustration of an embodiment of a table leg.

FIG. 3 is a side view of an embodiment of a locking device.

FIG. 4 is a front view of an embodiment of a bolt head for the locking device of FIG. 3.

FIG. 5 is an illustration of an embodiment of a washer with a locking pin.

FIG. 6 is a side view of the washer embodiment of FIG. 5.

FIG. 7 is an illustration of an embodiment of a folding leg in an “up” position.

FIG. 8 is an illustration of an embodiment of a folding leg in a “down” position.

FIG. 9 is an illustration of an embodiment of a bracket.

FIG. 10 is a top view illustration of the bracket embodiment of FIG. 9 and including a pivot bolt.

FIGS. 11 and 12 are top view illustrations of the bracket embodiment of FIG. 9 and including an embodiment of a table leg in first and second “up” positions.

FIG. 13 is a top view illustration of the bracket embodiment of FIG. 9 and including an embodiment of a table leg in a “down” position.

FIG. 14 is an illustration of an embodiment of a folding leg system mounted on a surface.

FIG. 15 is an illustration of another embodiment of a bracket.

FIG. 16 is an illustration of another embodiment of a table leg.

FIG. 17 is an illustration of another embodiment of a folding leg in a “down” position.

### DESCRIPTION

In the following figures and description, like numbers refer to like elements. References to “one embodiment” or “an embodiment” do not necessarily refer to the same embodiment, although they may.

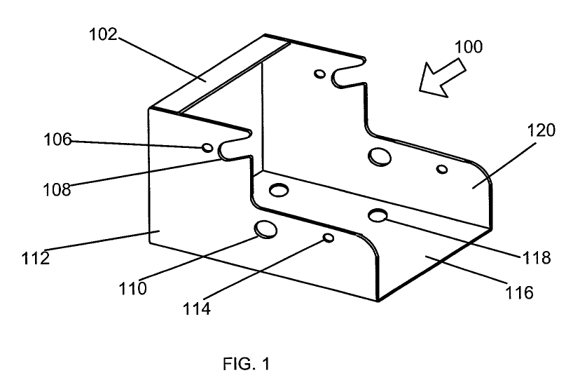

With reference to FIG. 1, an embodiment 100 of a bracket includes a back surface 104, a first side 112, a second side 120, and a bottom surface 116. A tab 102 may be formed by an approximately ninety degree bend in the back surface 104. The sides 112, 120 each include a slot 108, a pivot bolt hole 110, and first locking pin hole 106, and a second locking pin hole 114. Alternate embodiments may include one or both of the locking pin holes 106, 114 on only one of the sides 112, 120. The bottom surface 116 comprises mounting holes 118 through which bolts, screws, or other fasteners may pass to secure the bracket 100 to a surface.

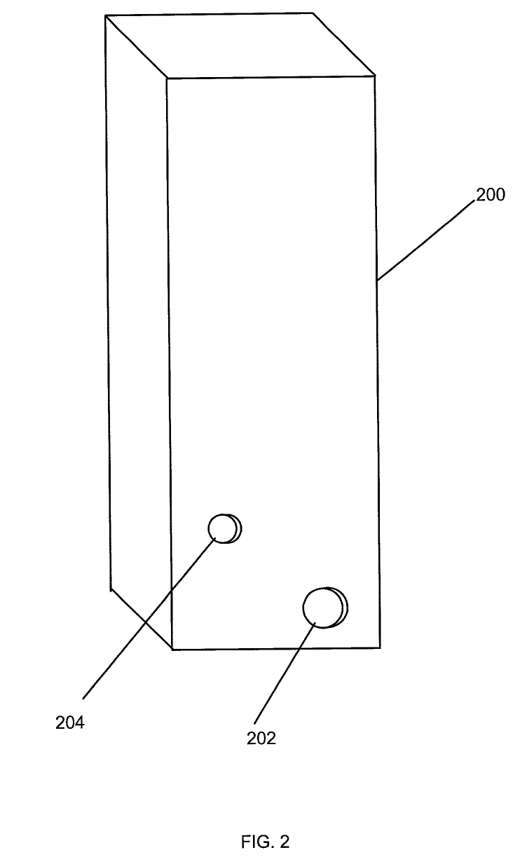

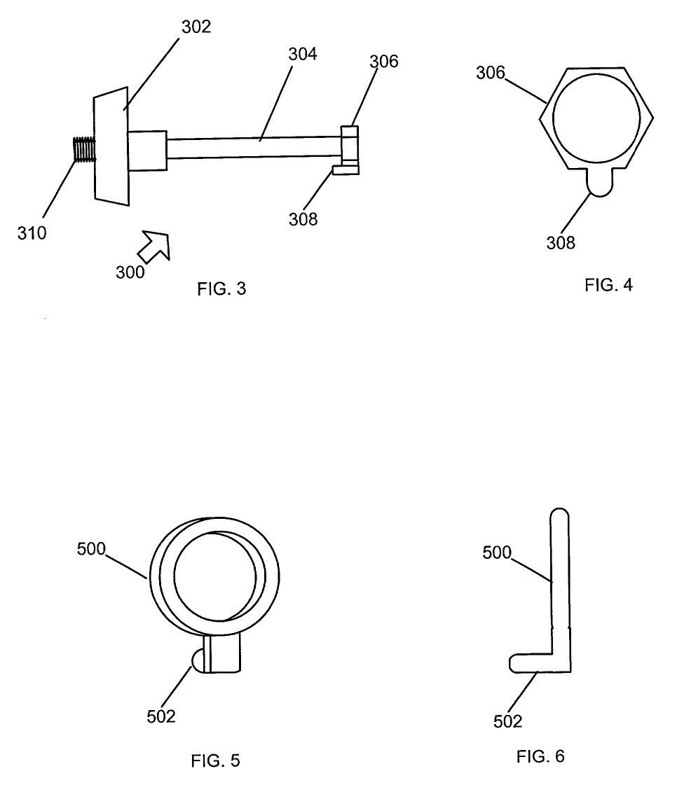

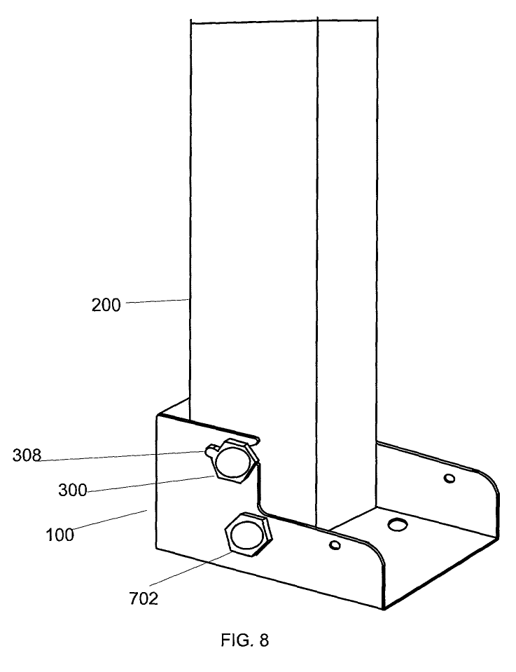

With reference to FIG. 2, an embodiment 200 of a leg section that may be employed with the bracket 100 includes a pivot bolt hole 202 and a locking pin hole 204. As will be described more fully with respect to FIGS. 7 and 8, the leg 200 may be positioned between the sides 112, 120 of the bracket 100 and a pivot bolt inserted through the holes 110, 202. The leg 200 may fold around an axis of the pivot bolt and may be locked in both the “up” and “down” positions using a locking device. FIGS. 3-6 illustrate certain embodiments of a locking device that may be employed for this purpose.

With reference to FIGS. 3 and 4, an embodiment of a locking device 300 comprises a modified bolt 304 (shaft) having a head 306 and a threaded end 310. The head 306 is formed to include a locking pin 308. The locking pin 308 is formed to fit into the locking pin holes 106, 114 of the bracket 100. A cap 302, nut, or other tightening mechanism may be fitted over the threaded end 310 to tighten the locking device 300 once it is in position.

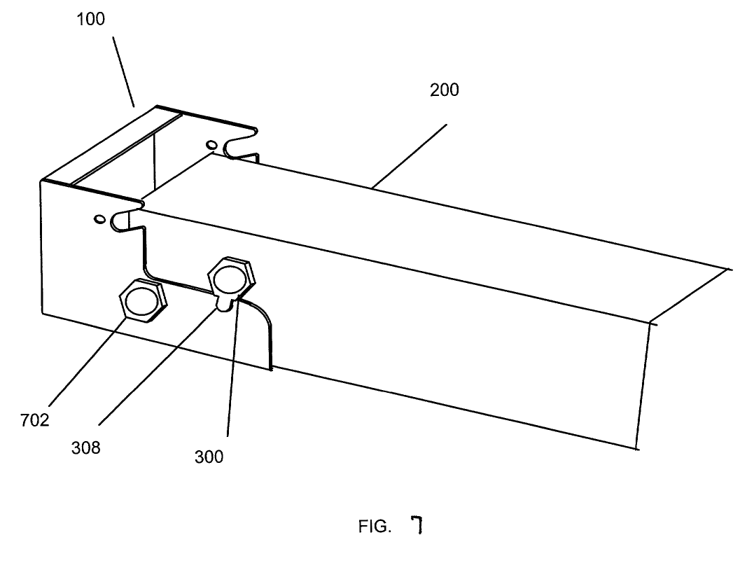

With reference to FIGS. 5 and 6, another embodiment of a locking device includes a washer 500 formed to include a locking pin 502. The washer 500 may be employed with a standard bolt to form a locking device, by positioning the washer between the head of the bolt and one of the sides 112, 120 of the bracket 100, with the locking pin 502 inserted into one of the holes 106, 114.

Of course, other embodiments of a locking device are also possible. For example, a shaft welded to the leg, and having at least one threaded end, may also serve as the locking device.

With reference to FIG. 7, an embodiment of a folding leg assembly includes the leg 200 locked in an “up” position. The up position may be desirable for transportation and/or storage of a table or other surface comprising the leg 200 and bracket 100. The leg 200 is positioned within the bracket 100. A pivot bolt (preferably a bolt having a threaded end, but generally any object providing a fixed axis of rotation) is inserted through the holes 110 of the bracket and the holes 202 of the leg 200. The bolt 304 of the locking device 300 is inserted through the holes 204 of the leg 200 with the locking pin 308 inserted into one of the holes 114 of the bracket 100. The cap 302 or other fastener (such as a standard nut) is then tightened onto the threaded end 310 of the bolt 304. The leg 200 is thus prevented from pivoting around the pivot bolt 702 while locked in place.

Another embodiment of the bracket may resemble the bracket 100, and may further comprise slots near the holes 114. In the up position, the bolt (shaft) 304 of the locking device 300 may be positioned in the slots near the holes 114 before the locking pin 308 is inserted into one of the holes 114 of the bracket. The cap 302 or other fastener may then be tightened onto the threaded end 310 of the bolt 304.

With reference to FIG. 8, an embodiment of a folding leg assembly includes the leg 200 locked in a “down” position. The down position is typically employed when a table or other surface comprising the leg 200 and bracket 100 are to be supported by one or more of the legs 200. The leg 200 is positioned within the bracket 100. To reach the down position from the up position, the locking device 300 is removed and the leg 200 is pivoted around the pivot bolt 702 to the down position. In the down position, the tab 102 prevents over-rotation of the leg 200. The bolt (shaft) 304 of the locking device 300 is inserted through the holes 204 of the leg 200 and positioned in the slots 108 of the bracket 100, with the locking pin 308 inserted into one of the holes 106. The cap 302 or other fastener is then tightened onto the threaded end 310 of the bolt 304. The leg 200 is thus prevented from pivoting around the pivot bolt 702 while locked in place.

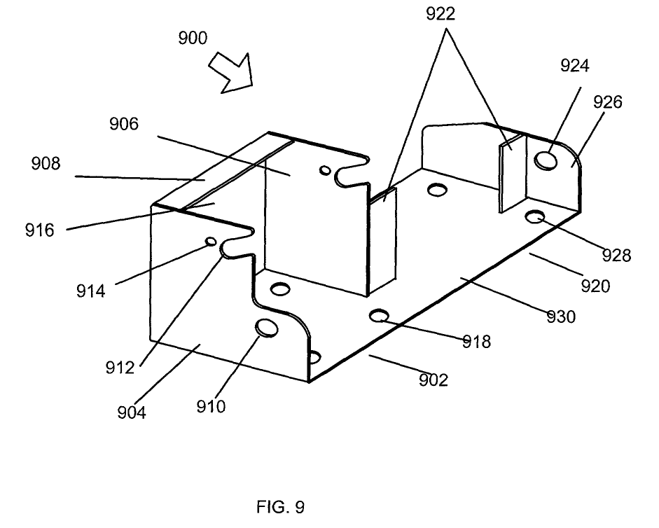

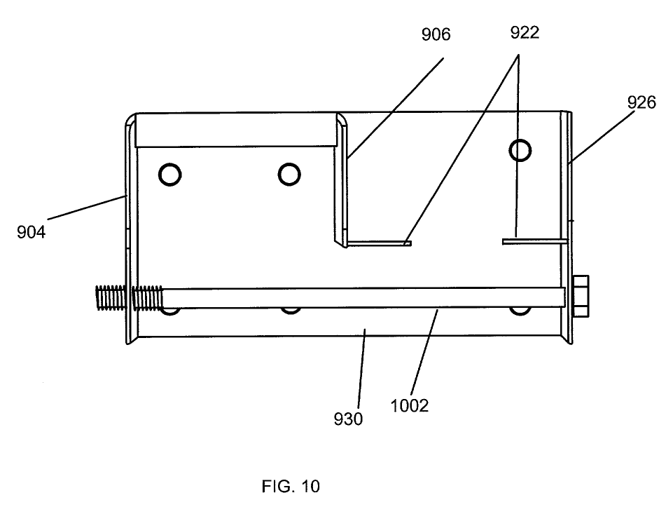

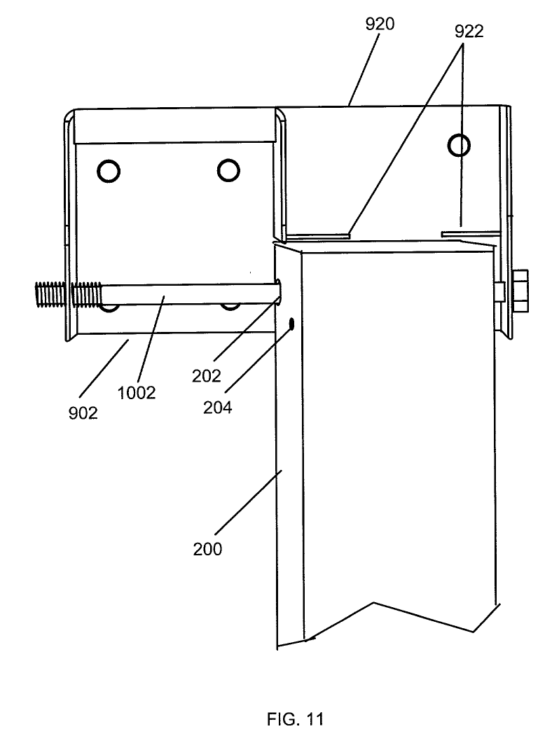

With reference to FIGS. 9 and 10, an embodiment 900 of a bracket includes a first section 902 and a second section 920. The first section 902 comprises a back surface 916, an outer side 904, and an inner side 906. The back surface 916 may be bent over to form a tab 908 to prevent over-rotation of a leg in the first section 902. A bottom surface 930 is shared by both sections 902, 920 and comprises mounting holes such as holes 918 and 928. The sides 904, 906 comprise slots 912 and locking pin holes 914.

The second section 920 comprises an outer side 926 and shares the inner side 906 with the first section 902. The outer section 920 further comprises tabs 922 which prevent a leg from rotating in the second section 920. A pivot bolt hole 924 of the side 926 is aligned with a pivot bolt hole 910 of the side 904.

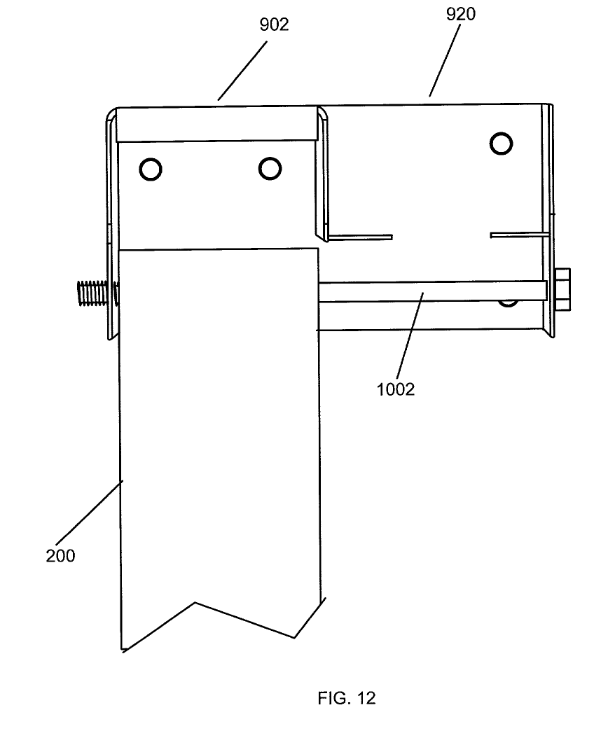

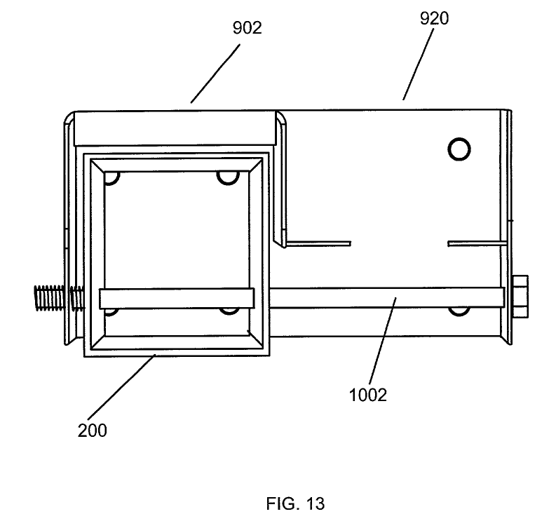

With reference to FIG. 10, a pivot bolt may be inserted through the holes 924, 910. Referring now to FIGS. 11-13, the pivot bolt 1002 may pass through the holes 202 of the leg 200. When the leg is in the second section 920, the tabs 922 prevent the leg from rotating abound the bolt 1002. Referring to FIG. 12, the bolt 1002 also acts as a guide for the leg 200 to slide from the second section 920 to the first section 902. In the first section 902 the leg 200 may then be rotated about the pivot bolt 1002 into the down position, in which it may be locked by the locking device 300 in the same manner as described for the bracket 100.

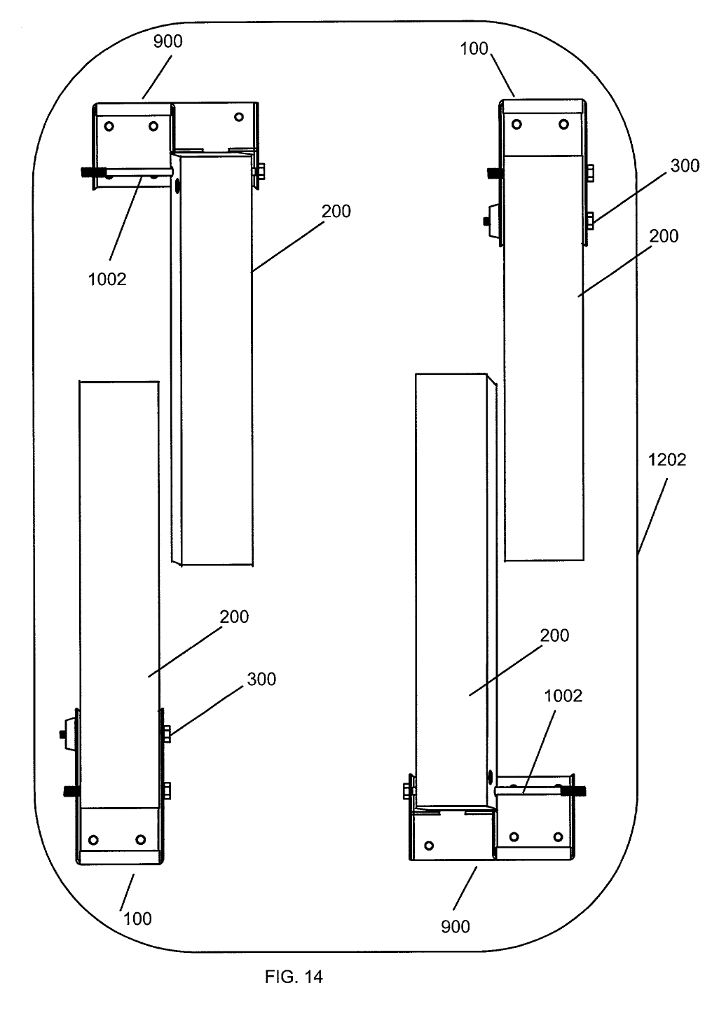

With reference to FIG. 14, the bracket embodiments 100, 900 may be employed together to provide an efficient, robust folding leg system without springs or complex moving parts. Two of brackets 100 and two of brackets 900 may be mounted on a surface 1202, with the first section 902 of the brackets 900 mounted in alignment with a corresponding bracket 100. During storage and transportation, the legs 200 of the brackets 100 may be locked in the up position using the locking device 300. The legs 200 of the bracket 900 may be prevented from rotating by the tabs 922. When the time comes to set up the surface for use, the legs 200 of the brackets 100 may be unlocked, rotated to the down position, and locked again. The legs 200 of the brackets 900 may slide along the bolts 1002 to the first section 902, and may then be rotated into the down position and locked using the locking device 300.

In an alternate embodiment, both of the brackets 900 are positioned on one side of the surface 1200 and both of brackets 100 on an opposite side. The first sections 902 of the brackets 900 are mounted in alignment with a corresponding bracket 100. In this alternate embodiment, one of the brackets 900 has the first and second sections 902, 920 switched in position (e.g. the first section 902 of one of the brackets 900 is in the position of the second section 920 of the other bracket 900). In other words, one of the brackets 900 is the “reverse” of the other.

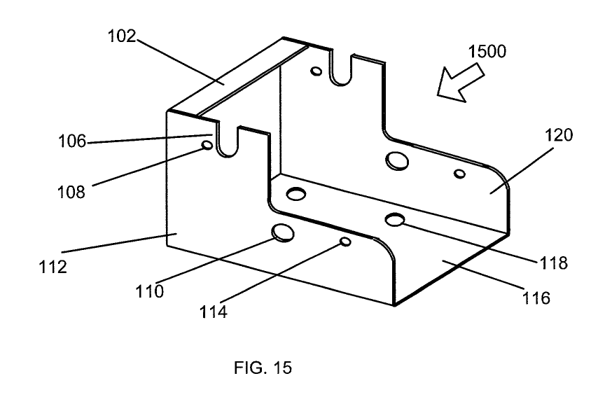

With reference to FIG. 15, an embodiment 1500 of a bracket includes a back surface 104, a first side 112, a second side 120, and a bottom surface 116. In contrast to the bracket embodiment 100 of FIG. 1, each slot 106 in located along an upper edge of the sides 112, 120.

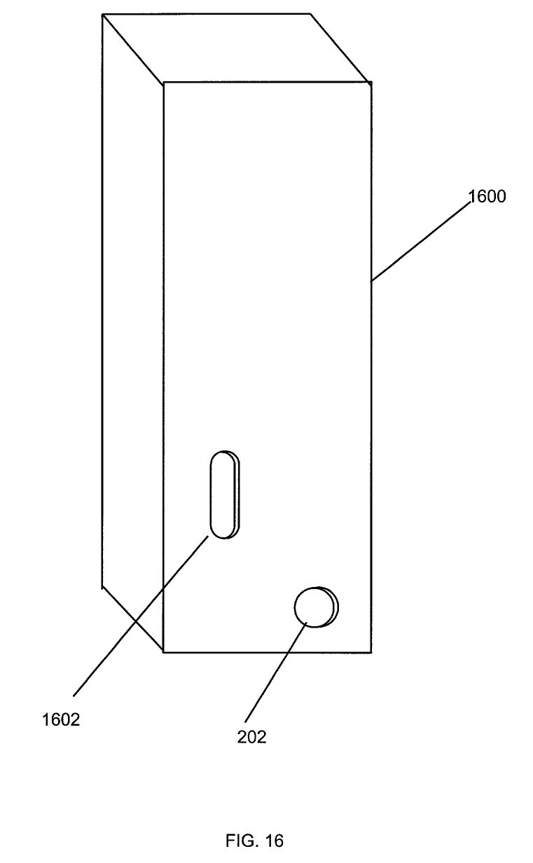

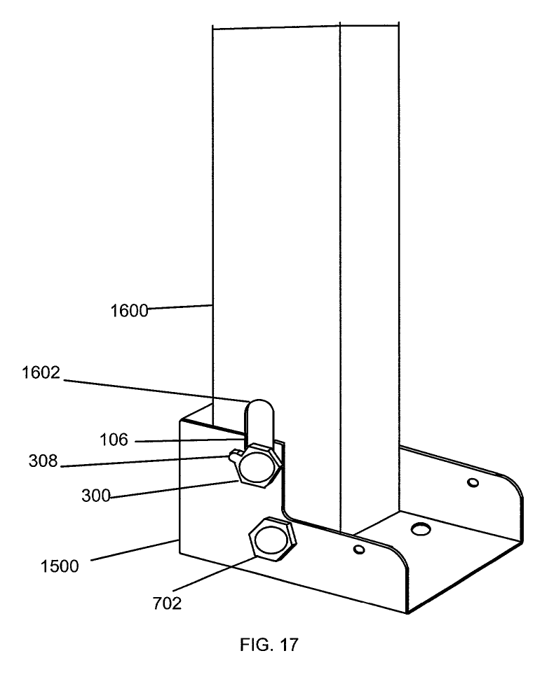

With reference to FIG. 16, an embodiment 1600 of a leg section that may be employed with the bracket 1500 includes a locking pin slot 1602. The leg 1600 may be positioned between the sides 112, 120 of the bracket 1500 and a pivot bolt inserted through the holes 110, 202. With reference to FIG. 17, the leg 1600 may fold around an axis of the pivot bolt into the down position, and a bolt 304 of a locking device 300 may translate within the slot 1602 into the slots 106 of the bracket 1500. The locking pin 308 may be inserted into one of the holes 114 of the bracket 1500. The cap 302 or other fastener is then tightened onto the threaded end 310 of the bolt 304. The leg 1600 is thus prevented from pivoting around the pivot bolt 702 while locked in place.

In view of the many possible embodiments to which the principles of the present invention may be applied, it should be recognized that the detailed embodiments are illustrative only and should not be taken as limiting in scope. Rather, the present invention encompasses all such embodiments as may come within the scope and spirit of the following claims and equivalents thereto.

What is claimed is:

1. A bracket comprising:
a plurality of holes to receive a pivot bolt;
a plurality of slots to receive the shaft of a locking device;
a first locking pin hole to receive a locking pin of the locking device when the shaft of the locking device is positioned in the slots; and
a second locking pin hole to receive the locking pin when the shaft of the locking device is not positioned in the slots.

2. The bracket of claim 1 further comprising:
a tab to prevent rotation of a leg around the pivot bolt beyond a down position of the leg.

3. A bracket comprising:
a plurality of holes to receive a pivot bolt along which a leg may slide from a first section of the bracket to a second section of the bracket;
the second section adapted so that the leg cannot rotate around the pivot bolt when the leg is in the second section;
the first section adapted so that the leg can rotate into a position wherein a shaft of a locking device of the leg is received into slots in sides of the first section, at least one of the sides having a locking pin hole to receive a locking pin of the locking device.

4. The bracket of claim 3 further comprising:
the second section comprising at least one tab to prevent rotation of the leg around the pivot bolt in the second section.

5. The bracket of claim 3 further comprising:
the first section comprising a tab to prevent rotation of the leg in the first section around the pivot bolt beyond a down position of the leg.

6. A folding leg system, comprising:
a first leg adapted to receive a first pivot bolt;
a first bracket mounted on a surface, the first bracket coupled to the first leg by way of the first pivot bolt such that the first leg can rotate in the first bracket between an up and a down positions,
a second leg adapted to receive a second pivot bolt;
a second bracket mounted on the surface, the second bracket coupled to the second leg by way of the second pivot bolt, the second bracket having a first section in which the second leg may rotate to a down position from an up position and a second section in which the leg is prevented from rotating into the down position from the up position, the second bracket adapted so that the second leg may slide along the pivot bolt from the first to the second sections; and
wherein the first bracket is mounted on the surface across from the second bracket, such that the first leg does not contact the second leg when the first and second legs are in the up position and the second leg is in the second section of the second bracket.

7. The system of claim 6, further comprising:
the first bracket having a first locking pin hole to receive a first locking pin when the first leg is in an up position; and
the first bracket having a second locking pin hole to receive the first locking pin when the first leg is in a down position.

8. The system of claim 7, further comprising:
the second bracket having a third locking pin hole to receive a second locking pin when the second leg is in a down position.

9. The system of claim 6, further comprising:
the first bracket comprising first slots to receive a shaft of a first locking device when the first leg is in the down position; and
the second bracket comprising second slots to receive a shaft of a second locking device when the second leg is in the down position.

10. The system of claim 9 wherein the first locking device and the second locking device each comprise a washer, each washer having a locking pin.
